(19) United States
(12) Patent Application Publication
(10) Pub. No.: US 2006/0263191 A1
(43) Pub. Date: Nov. 23, 2006

(54) Self-propelled working machine

(76) Inventors: Osamu Gokita, Ibaraki (JP); Yoshio Namai, Ibaraki (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 10/547,331

(22) PCT Filed: Jul. 23, 2004
(86) PCT No.: PCT/JP04/02934

§ 371 Date: Sep. 1, 2005

(30) Foreign Application Priority Data
Mar. 18, 2003 (JP) 2003-073819

(51) Int. Cl. B66C 23/00

(52) U.S. Cl. 414/695

(57) ABSTRACT

A tool repositioning mechanism (20) is provided between a fore end of a telescopic boom (12) and a cargo handling tool (35). The tool repositioning mechanism (20) is constituted by a head member (21), swing arm (25), swing cylinder (29), tool mount member (30) and a link (34). As a swing cylinder (29) is expanded or contracted, the cargo handling tool (35) is shifted to the right or to the left of the telescopic boom (12) through the tool repositioning mechanism (20). Accordingly, even if a spot of a lifted cargo on the cargo handling tool (35) is deviated from a cargo unloading spot in a lateral direction, the position of the lifted cargo can be adjusted easily by the tool repositioning mechanism (20) to unload the cargo accurately on a specified spot.

### TECHNICAL FIELD

This invention relates to an automotive working machine which is provided with an automotive vehicular body, for example, like a lift truck.

### BACKGROUND ART

Generally, automotive working machines with an automotive vehicular body and a boom mechanism liftably mounted on the automotive vehicular body have been known to use for lifting and transferring freight goods up and down (for a cargo handling job) or for performing a job at an elevated place like maintenance and service of power cables (e.g., Japanese Patent No. 2559831).

The boom mechanism on the lift truck according to the above-mentioned prior art is of a multi-step telescopic boom which is liftably supported on a vehicle body at its base end and extended and contracted in longitudinal direction at its fore end. A working tool like a fork is attached to a foremost one of telescopically connected boom portions. After transferring loaded freight goods on the working tool to a specified cargo unloading spot, the telescopic boom is raised to an elevated position and freight goods are dumped on the specified cargo unloading spot by extending or retracting the telescopic boom in longitudinal direction.

Normally, the boom mechanism on the above-described lift truck can be lifted up and down on the vehicle body, but cannot be turned in a lateral direction, that is, in a rightward or leftward direction.

Therefore, when the position of a lifted cargo of goods on a boom mechanism is found to be deviated from a specified cargo unloading spot in a lateral direction, it has been necessary for a prior art lift truck as mentioned above to lower the elevated boom again and to move the vehicle once again for adjusting the position of the cargo in a rightward or leftward direction into alignment with the specified cargo unloading spot.

On the other hand, there have been known another type of lift trucks which are equipped with a boom which can be swung laterally in rightward and leftward directions (e.g., as disclosed in British Patent Laid-Open No. 2121363).

In the other case of a lift truck of this type, a base end portion of a boom is supported on a chassis which is movable in rightward and leftward directions for swinging the boom arcuately in a rightward or leftward direction to turn a working tool on a fore end portion of the boom in a rightward or leftward direction toward an aimed spot.

However, difficulties are experienced with the lift truck of this type having a boom supported on a chassis which is movable in rightward and leftward directions to swing a fore end of the boom arcuately in a rightward or leftward direction.

In this case, a working tool which is attached to a fore end of the boom is likewise swung arcuately in a rightward or leftward direction to confront an cargo unloading spot at a irregular varied angle. Namely, in this case, it is difficult to bring a cargo of goods on the working tool at the fore end of the boom into a regularly confronting position relative to a specified cargo unloading spot, that is to say, it is difficult to unload the cargo on the specified spot from a right direction.

### DISCLOSURE OF THE INVENTION

In view of the above-discussed problems with the prior art, it is an object of the present invention to provide an automotive working machine which can be turned a working tool in rightward or leftward direction of a telescopic boom to shift a lifted cargo on the boom into a regularly confronting position relative to a specified cargo unloading spot.

In accordance with the present invention, in order to achieve the above-stated objective, there is provided an automotive working machine having an automotive vehicle body, and a load lifting boom mechanism liftably supported on the vehicle body, the boom mechanism being provided with a multi-step telescopic boom supported on said vehicle body at its base end liftable up and down and contractibly extensible, and a working tool attached to a foremost boom section of the telescopic boom.

The automotive working machine according to the present invention is characterized by the provision of a tool repositioning mechanism located between the foremost boom and the working tool and adapted to shift the working tool laterally in a rightward or leftward direction relative to the telescopic boom for repositioning the working tool in a lateral direction.

According to the present invention, in case a lifted cargo on the working tool is found to be deviated from a specified cargo unloading spot in a lateral direction, the cargo position can be easily adjusted by the tool repositioning mechanism to take a regularly confronting position relative to the specified unloading spot, permitting to transfer and unload a cargo of freight goods accurately on a specified spot.

According to a preferred form of the present invention, the tool repositioning mechanism comprises, a head member provided on a fore end portion of the foremost boom, a swing arm having a base end pivotally supported on the head member through a first link pin for rightward and leftward swinging movements relative to the head member, a swing cylinder connected between the head member and the swing arm to swing the swing arm in a rightward or leftward direction relative to the head member, a tool mount member pivotally supported on a fore end portion of the swing arm through a second link pin for rightward and leftward swinging movements about the second link pin along with said working tool, and a link connected between the head member and the tool mount member to maintain the tool mount member substantially in a parallel relation with the head member.

With the just-described arrangements according to the present invention, when the swing arm is swung by expansion or contraction of the swing cylinder, the tool attaching member is maintained substantially in a parallel posture by the link relative to the head member. Therefore, the working tool which is attached to the tool mount member is shifted to the right or to the left of the boom along with the loaded cargo, for bringing the lifted cargo by the working tool into a regularly confronting position relative to a specified cargo unloading spot.

Further, according to the present invention, the first link pin is so located as to take substantially a parallel position relative to a ground surface when the telescopic boom is folded to ground surface. Accordingly, in order to ensure safe travel on a public road, the working tool can be raised away from a ground surface simply by swinging same in a rightward or leftward direction through the swing cylinder with the telescopic boom in the flatly folded position. Since the working tool can be raised without lifting the telescopic boom, the operator can drive the machine with an unobstructed broad view field in the forward direction.

Further, according to the present invention, the working tool is pivotally supported on the tool mount member through a support pin for upward and downward swing movements about the support pin, further comprising a tool cylinder connected between the working tool and the tool attaching member to swing the working tool. Accordingly, the working tool can be swung in an upward or downward direction by expanding or contracting the tool cylinder according to elevation angle of the telescopic boom, for maintaining a cargo constantly in a stabilized state while being lifted and transferred to a specified cargo unloading spot by the boom mechanism irrespective of the elevation angle of the telescopic boom.

According to another preferred form of the present invention, the swing cylinder and the link are located collectively at one side of the swing arm. In this case, a broader view field can be secured on the right and left side of the swing arm.

According to still another preferred form of the present invention, the swing cylinder and the link are located on opposite sides of the swing arm. This arrangement contributes to enhance stability of the vehicle body in travel or at work.

According to the present invention, the tool cylinder can be connected between the tool mount member and the working tool on the front side of the swing arm.

Further, according to the present invention, the tool cylinder can be connected between the tool mount member and the working tool on the back side of the swing arm in such a way as to utilize pressure in a bottom-side oil chamber for supporting loads exerted thereto by the working tool. While using the pressure in the bottom side oil chamber of the tool cylinder, the loads supporting to the tool cylinder can be exerted. As a consequence, even if a large load is imposed on the tool cylinder from the side of the working tool, it can be securely supported by the tool cylinder to ensure enhanced performance in cargo handling operations. In addition, in this case, it becomes possible to downsize the tool cylinder (to reduce the diameter of the tool cylinder).

Further, according to the present invention, the tool mount member is provided with a couple of right and left cylinder attaching plates faced toward each other on the back side of the swing arm and extended in the longitudinal direction of the swing arm in spaced relations with each other, the tool cylinder being located in position between the right and left cylinder attaching plates and connected between the tool mount member and the working tool. In this case, since the tool cylinder is located between the right and left cylinder attaching plates of the tool mount member, it becomes possible to minimize the size between the front and back sides of the tool repositioning mechanism. Besides, in this case, the right and left cylinder attaching plates of the tool mount member can serve as protective covers for the tool cylinder.

Further, according to the present invention, the telescopic boom is held in an inclined down posture when flatly folded to ground surface, having a fore end located at a lower position than a base end thereof. Therefore, even if the working tool is raised away from a ground surface when shifted in a rightward or leftward direction by the tool repositioning mechanism, it can be lowered or put on a ground surface simply by extending the boom. Therefore, at the time of lifting a cargo by a building wall, for example, the working tool can be lowered and set on the ground alongside the building wall to handle the cargo in an efficient manner.

### BRIEF DESCRIPTION OF THE DRAWINGS

In the accompanying drawings:

FIG. 1 is a front view of a lift truck to which an embodiment of the present invention is applied;

FIG. 2 is a perspective view of a telescopic boom, tool repositioning mechanism and cargo handling tool shown in FIG. 1;

FIG. 3 is a front view on an enlarged scale, showing the telescopic boom, tool repositioning mechanism and cargo handling tool of FIG. 1;

FIG. 4 is a left-hand side view taken in the direction of arrows IV-IV of FIG. 3, showing the telescopic boom, tool repositioning mechanism and cargo handling tool in intermediate positions;

FIG. 5 is a left-hand side view similar to FIG. 4 but showing the telescopic boom, tool repositioning mechanism and cargo handling tool in rightward shifted positions;

FIG. 6 is a left-hand side view similar to FIG. 4 but showing the telescopic boom, tool repositioning mechanism and carbo handling tool in leftward shifted positions;

FIG. 7 is a diagram of a hydraulic circuit for driving a boom lifting cylinder, a first step boom cylinder, a second step boom cylinder, a swing cylinder and a working tool cylinder;

FIG. 8 is a front view similar to FIG. 3 but showing a tool repositioning mechanism and a cargo handling tool in a second embodiment of the present invention;

FIG. 9 is a left-hand side view taken in the direction of arrows IX-IX in FIG. 8, showing the tool repositioning mechanism and the cargo handling tool in intermediate positions;

FIG. 10 is a left-hand side view of the tool repositioning mechanism and the cargo handling tool in rightward shifted positions;

FIG. 11 is a left-hand side view of the tool repositioning mechanism and the cargo handling tool in leftward shifted positions; and

FIG. 12 is a front view similar to FIG. 3 but showing a modification employing a excavating tool as a working tool.

### BEST MODE FOR CARRYING OUT THE INVENTION

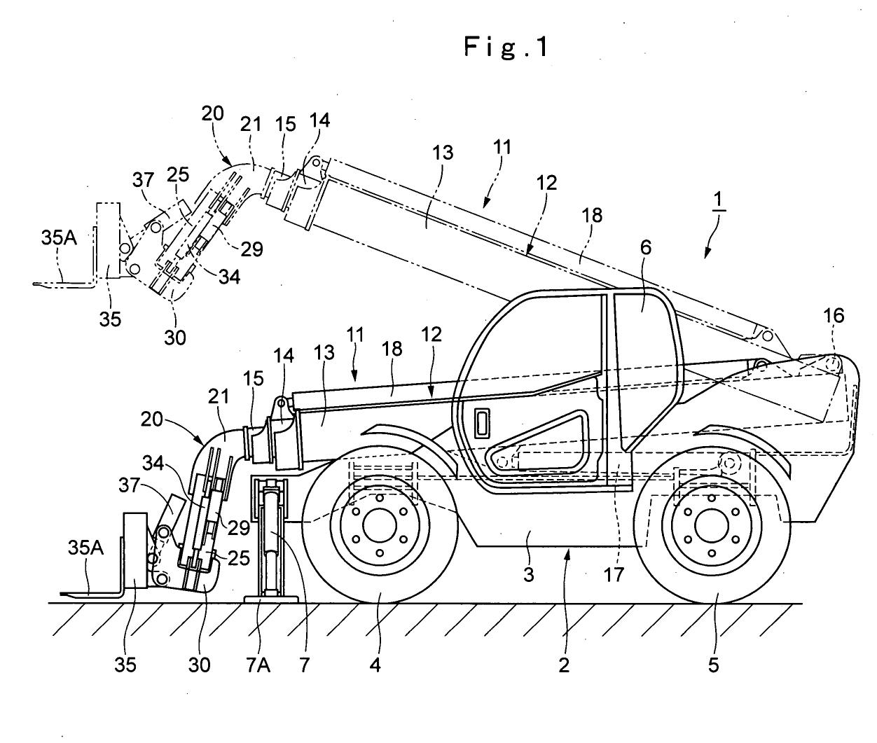

With reference to FIGS. 1 through 12, the automotive working machine according to the present invention is described more particularly hereafter by way of its preferred embodiments which are applied to a lift truck.

Shown in FIGS. 1 through 7 is a first embodiment of the present invention. In these figures, indicated at 1 is a lift truck, which is largely constituted by an automotive wheeled vehicle body 2, and a lifting boom mechanism 11 which will be described hereinafter. The lift truck 1 is used mainly for cargo handling jobs, putting the vehicle body 2 in travel and lifting cargoes from the ground to higher position by the boom mechanism 11.

In this instance, the vehicle body 2 is formed by the use of relatively thin steel plates, and largely constituted by a frame 3 which is extended toward the front and rear ends of the vehicle body 2, drive sources including an engine, hydraulic pump and hydraulic motor (all not shown in the drawing) which are mounted on the frame 3, and a cab 6 which will be described hereinafter. Right and left front wheels 4 are provided in a front side of the frame 3 (only a left front wheel is shown in the drawings), while right and left rear wheels 5 are provided in a rear side of the frame 3 (only a left rear wheel is shown in the drawings). The right and left front wheels 4 as well as the right and left rear wheels 5 are simultaneously driven from a vehicle drive hydraulic motor (not shown) to drive the vehicle body 2 forward and backward by 4-wheel drive.

Indicated at 6 is a cab which is mounted at a longitudinally intermediate position on the frame 3 and located between the left front and rear wheels 4 and 5 and an operator's room is formed in the cab 6. An operator's seat to be seated by an operator is provided within the cab 6 along with a steering device for the front and rear wheels 4 and 5 and control levers (all not shown) for operating the boom mechanism 11 which will be described hereinafter.

Further, right and left stabilizers 7 (only a left stabilizer is shown in the drawings) are provided on opposite sides of a front end portion of the frame 3 and forward of the front wheels 4. When the vehicle body 2 is in put in travel, footing plates 7A of the stabilizers 7 are turned up away from the ground surface, and, when the lift truck is at cargo handling work by the use of the boom mechanism 11, the respective footing plates 7A are set on the ground to stabilize the vehicle body 2.

Indicated at 11 is a boom mechanism which is liftably provided on the vehicle body 2. This boom mechanism 11 is constituted by a multi-step telescopic boom 12, a boom lifting cylinder 17, a first step boom cylinder 18, a second step boom cylinder 19, a tool repositioning mechanism 20 comprised of a link mechanism, a cargo handling tool 35 and a tool cylinder 37, which will be described hereinafter. A cargo of goods which is loaded on the cargo handling tool 35 is lifted up from a ground level and transferred to a specified cargo unloading spot.

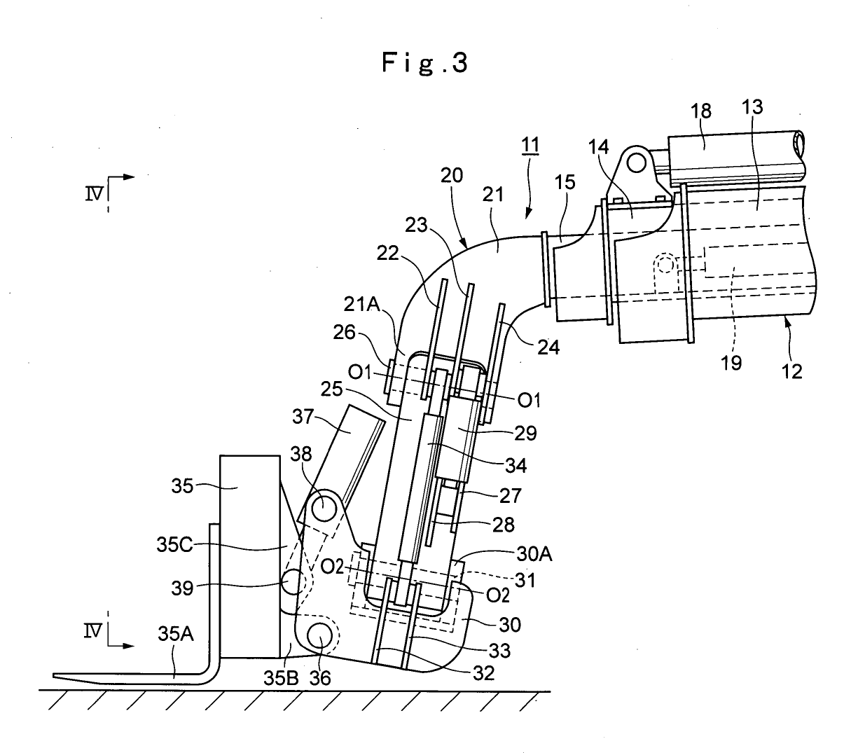

Denoted at 12 is a multi-step telescopic boom employed for the boom mechanism 11. As shown in FIG. 3, this telescopic boom 12 is constituted by an outermost first step boom 13 in the form of a square tube, a second step boom 14 in the form of a square tube which is extendibly received in the first step boom 13, and a third step boom 15 as the foremost boom which is extendibly received in the second step boom 14. Thus, the telescopic boom 12 is extendible and contractible in the longitudinal direction.

The rear or base end of the first step boom 13 is pivotally supported on a rear end portion of the vehicle body 2 (of the frame 3) through a support pin 16 (FIG. 1). Attached to a fore end of the foremost third step boom 15 is a tool repositioning mechanism 20 which will be described hereinafter.

Indicated at 17 is a boom lifting cylinder which is provided between the frame 3 of the vehicle body 2 and the first step boom 13. The bottom side of this boom lifting cylinder 17 is pivotally connected to the frame 3 through a pin, while the rod side is pivotally connected to a lower side of the first step boom 13 through a pin. By this boom lifting cylinder 17, the telescopic boom 12 is elevated up and down between a flatly folded position on the side of a ground surface (the position indicated by solid line in FIG. 1) and an upper elevated position away from a ground surface (the position indicated by two-dot chain line in FIG. 1).

In this instance, when the telescopic boom 12 is in the flatly folded position indicated by solid line in FIG. 1, the fore end of the third step boom 15 is located at a lower level than the base end portion of the first step boom 13 which is supported on the frame 3 by the support pin 16, and obliquely inclined downward toward a ground surface.

Indicated at 18 is a first step boom cylinder which is provided between the first step boom 13 and the second step boom 14. This first step boom cylinder 18 is located on the top side of the first step boom 13. The bottom side of this first step boom cylinder 18 is connected to a base end side (rear end side) of the first step boom 13, while the rod side is connected to a fore end side (a front end side) of the second step boom 14. By the first step boom cylinder 18, the second step boom 14 is either retracted into the first step boom 13 or extended out of the first step boom 13.

Designated at 19 is a second step boom cylinder which is provided between the second step boom 14 and the third step boom 15. This second step boom cylinder 19 is located within the third step boom 15, and its bottom and rod sides are connected to rear end of the second step boom 14 and fore end of the third step boom 15, respectively. The second step boom cylinder 19 is operated in step with the first step boom cylinder 18 to retract the third step boom 15 into a retracted position within the second step boom 14 or to extend the third step boom 15 to an expanded position out of the second step boom 14.

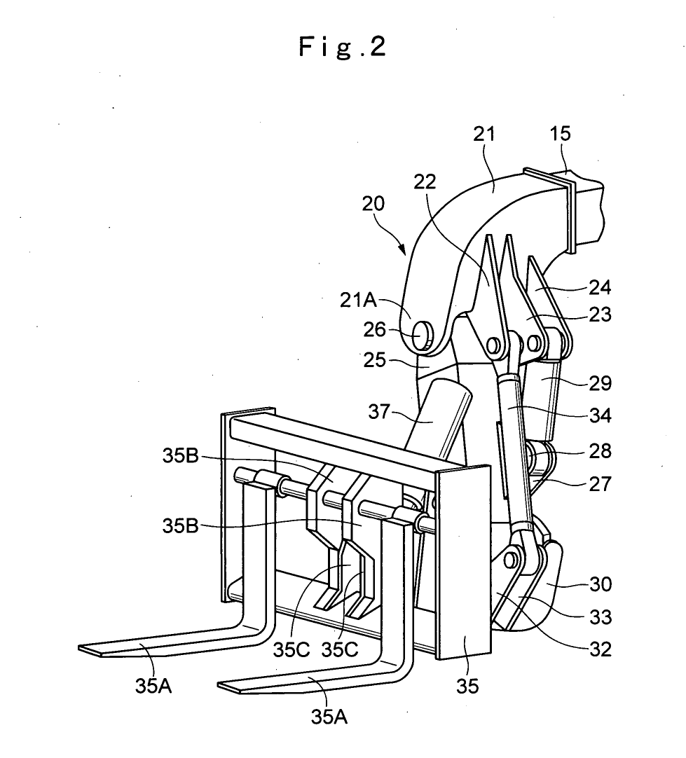

Indicated at 20 is a tool repositioning mechanism which is provided between fore end of the third step boom 15 and the cargo handling tool 35 which will be described hereinafter. This tool repositioning mechanism 20 functions to move the cargo handling tool 35 in a rightward or leftward direction relative to the telescopic boom 12. As shown in FIGS. 2 through 7, the tool repositioning mechanism 20 is built as a link mechanism which is constituted by a plural number of links including a head member 21, a swing arm 25, a swing cylinder 29, a tool mount member 30 and a link 34.

Denoted at 21 is a head member which is securely fixed to fore end of the third step boom 15. This head member 21 is extended from the third step boom 15 in an obliquely downward direction in the fashion of elephant's trunk. A fore distal end of the head member 21 is provided with a bifurcated portion 21A for gripping from front and rear sides a base end portion of a swing arm 25 which will be described hereinafter. Three brackets 22, 23 and 24 are projected from a left side of the head member 21 at predetermined intervals. Pivotally supported by a pin between the brackets 22 and 23 is a base end portion of a link 34 which will be described hereinafter, while pivotally supported by a pin between the brackets 23 and 24 is a bottom side of a swing cylinder 29 which will also be described hereinafter.

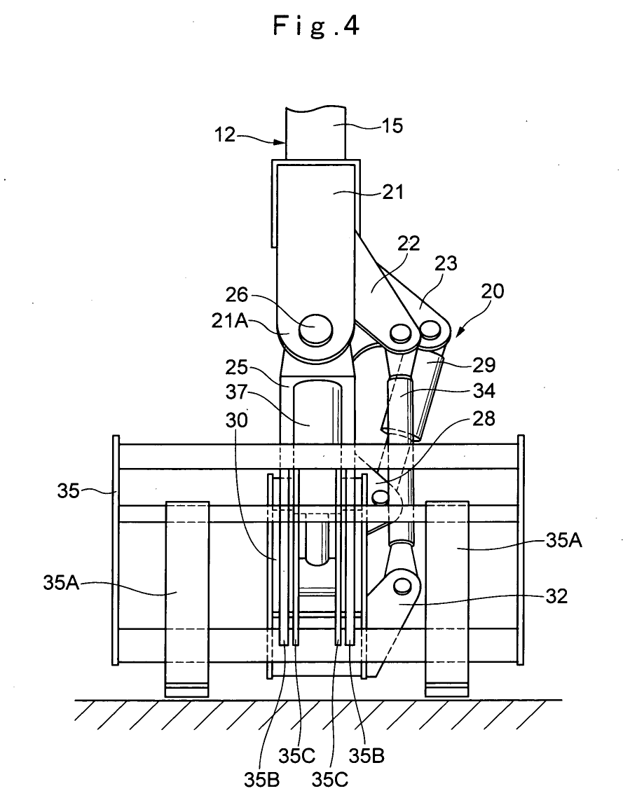

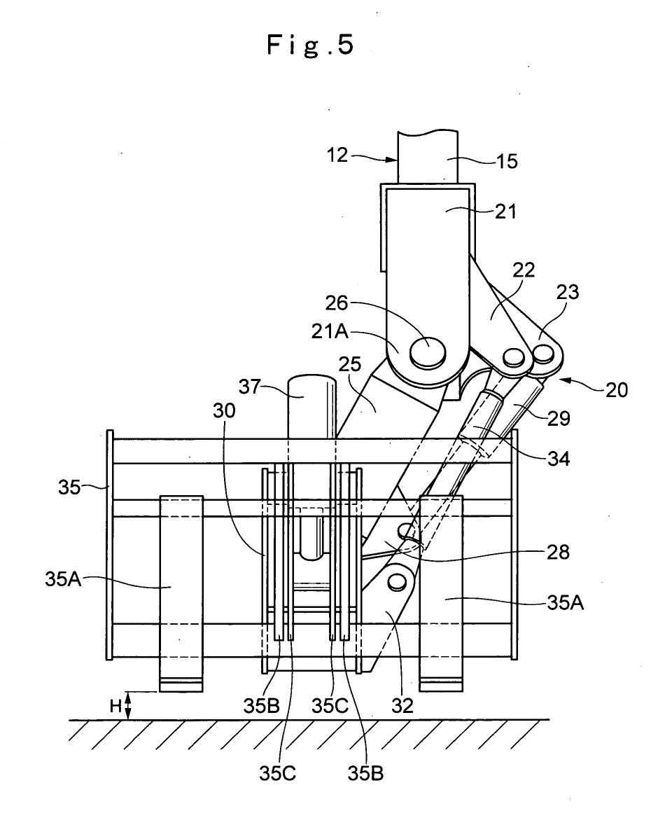

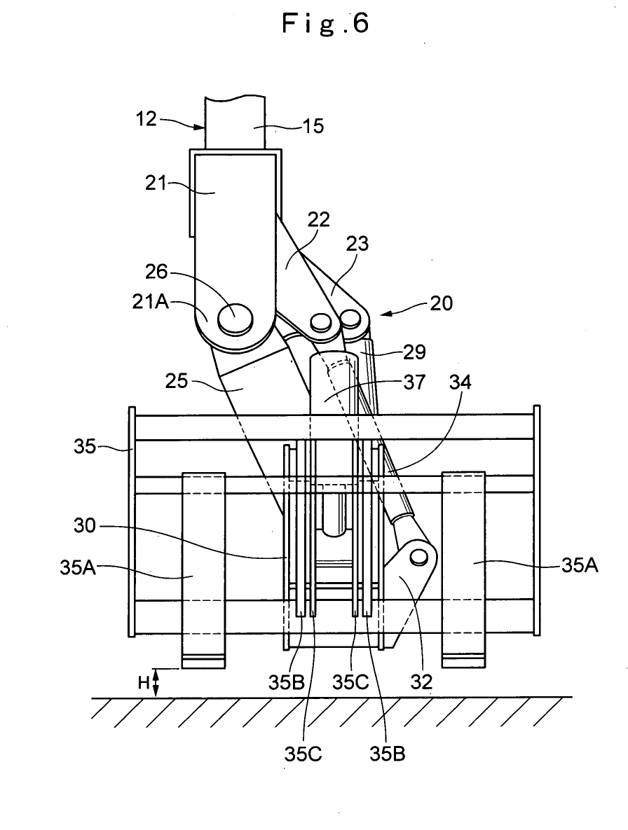

Indicated at 25 is a swing arm which is swingably suspended from the head member 21 for rightward and leftward swinging movements. More particularly, the base or upper end side of the swing arm 25 is swingably supported on a first link pin 26 between the bifurcated portion 21A of the head member 21. A couple of brackets 27 and 28 are projected from the left side of the swing arm 25 at predetermined spaced positions, and a rod side of a swing cylinder 20, which will be described hereinafter, is pivotally supported between the brackets 27 and 28 by a pin. As the swing cylinder 29 is expanded, the swing arm 25 is swung in a rightward direction about the first link pin 26 (a fulcrum pin) to shift its position from a center position of FIG. 4 to a rightward shifted position shown in FIG. 5. On the other hand, as the swing cylinder 29 is contracted, the swing arm 25 is swung in a leftward direction to shift its position from the center position in FIG. 4 to a leftward shifted position in FIG. 6.

In this instance, the first link pin 26 is located in position such that its center axis 01-01 comes into substantially parallel relation with a ground surface when the telescopic boom 12 is lowered into a folded position on the side of the ground surface as shown in FIG. 3. Consequently, when the swing arm 25 is swung in a rightward or leftward direction by the swing cylinder 29 while the telescopic boom 12 is in the lower folded position on the side of a ground surface, the fore end of the swing arm 25 is moved away from the ground surface to higher direction. Accordingly, as shown in FIGS. 5 and 6, the cargo handling tool 35, which will be described hereinafter, is raised to a height H above a ground surface on a swinging movement of the swing arm 25.

Indicated at 29 is a swing cylinder which is located on the left side of the swing arm 25 and connected between the head member 21 and the swing arm 25. Bottom side of this swing cylinder 29 is pivotally supported by a pin between the brackets 23 and 24 which are provided on the head member 21, while rod side of the swing cylinder 29 is pivotally supported by a pin between the brackets 27 and 28 which are provided on the swing arm 25. Accordingly, as the swing cylinder 29 is expanded or contracted, the swing arm 25 is swung in a leftward or rightward direction about the first link pin 26.

Designated at 30 is a tool mount member which is supported on a fore end portion of the swing arm 25 by a second link pin 31 for swinging movement in rightward and leftward directions. This tool mount member 30 is provided for attaching a cargo handling tool 35 which will be described hereinafter. In this instance, the tool mount member 30 is provided with a bifurcated portion 30A for holding a fore end portion of the swing arm 25 from front and rear sides. The bifurcated portion 30A is pivotally supported on a fore end portion of the swing arm 25 for rightward and leftward swinging movements about the second link pin 31. Further, at a predetermined interval, a couple of brackets 32 and 33 are projected from the left side of the tool mount member 30, and a fore end portion of a link 34 is pivotally supported between the brackets 32 and 33 through a pin.

In this case, as shown in FIG. 3, the second link pin 31 is located such that its center axis 02-02 comes into substantially parallel relation with a ground surface when the telescopic boom 12 is folded toward the ground surface. That is to say, the center axes 01-01 and 02-02 of the first and second link pins 26 and 31 are disposed parallel with each other.

Indicated at 34 is a rod-like link which is provided between the head member 21 and the tool mount member 30. This link 34 is collectively located on the left side of the swing arm 25 along with the swing cylinder 29 to secure a wide view field on the right side of the swing arm 25. In this instance, a base end portion of the link 34 is pivotally supported between the brackets 22 and 23 of the head member 21 by a pin and a fore end portion of the link 34 is supported between the brackets 32 and 33 by a pin. As shown in FIGS. 4 through 6, together with the head member 21, swing arm 25 and tool mount member 30, the link 34 constitutes a parallel link mechanism to keep the posture of the tool mount member 30 substantially in parallel relation with the head member 21 when the swing arm 25 is swung in a rightward or leftward direction by the swing cylinder 29.

Indicated at 35 is a cargo handling tool which is pivotally supported on the tool mount member 30 by a support pin 36 for swing movements thereabout. This cargo handling tool 35 is constituted by a rectangular frame-like structure with a fork 35A on the front side for loading a cargo of goods thereon. In this instance, tool stay attaching plates 35B and cylinder attaching plates 35C are projected on the back side of the cargo handling tool 35. The tool stay attaching plates 35B are located at the lower end of the cargo handling tool 35 and under the cylinder attaching plates 35C. The tool stay attaching plates 35B are pivotally supported on the tool mount member 30 by a support pin 36 for swing movements thereabout.

Accordingly, as the swing cylinder 29 of the tool repositioning mechanism 20 is expanded, the swing arm 25 is swung about the first link pin 26 to shift its position from the center position in FIG. 4 toward the rightward shifted position in FIG. 5. At this time, the tool mount member 30 at the fore end of the swing arm 25 is swung rightward along with the swing arm 25, keeping substantially parallel relations with the head member 21 through the link 34. Thus, the cargo handling tool 35 which is supported on the tool mount member 30 can be shifted in the rightward direction relative to the telescopic boom 12.

On the other hand, as the swing cylinder 29 of the tool repositioning mechanism 20 is contracted, the swing arm 25 is swung about the first link pin 26 to shift its position from the center position in FIG. 4 toward the leftward shifted position in FIG. 6. At this time, the tool mount member 30 is swung in the leftward direction along with the swing arm 25, keeping substantially parallel relations with the head member 21. Thus, the cargo handling tool 35 which is supported by the tool mount member 30 can be shifted in the leftward direction relative to the telescopic boom 12.

The cargo handling tool 35 is located at the lowest level when the swing arm 25 is in the center position shown in FIG. 4, and elevated to a greater height when the swing arm 25 is swung in a leftward or rightward direction by the swing cylinder 29 as shown in FIGS. 5 and 6.

Indicated at 37 is a tool cylinder which is located on the front side of the swing arm 25 and connected between the tool mount member 30 and the cargo handling tool 35. This tool cylinder 37 is actuated at the time of swing the cargo handling tool 35 up and down relative to the tool mount member 30. In this instance, pins 38 are projected from lateral sides of the tube of the tool cylinder 37, and these pins 38 are pivotally connected to the tool mount member 30. On the other hand, rod side of the tool cylinder 37 is pivotally connected to the cylinder attaching plates 35C of the cargo handling tool 35 through a pin 39.

Accordingly, as the tool cylinder 37 is expanded and contracted, the cargo handling tool 35 can be rocked up and down about the support pin 36. Therefore, as the telescopic boom 12 is from the lower folded position to the upper or elevated position indicated by solid and two-dot chain line in FIG. 1, the cargo handling tool 35 is swung according to the elevation angle of the telescopic boom 12 to keep the fork 35A substantially in a horizontal state, permitting to lift up and transfer loaded freight goods on the cargo handling tool 35 (fork 35A) toward a specified cargo unloading spot in a stabilized state.

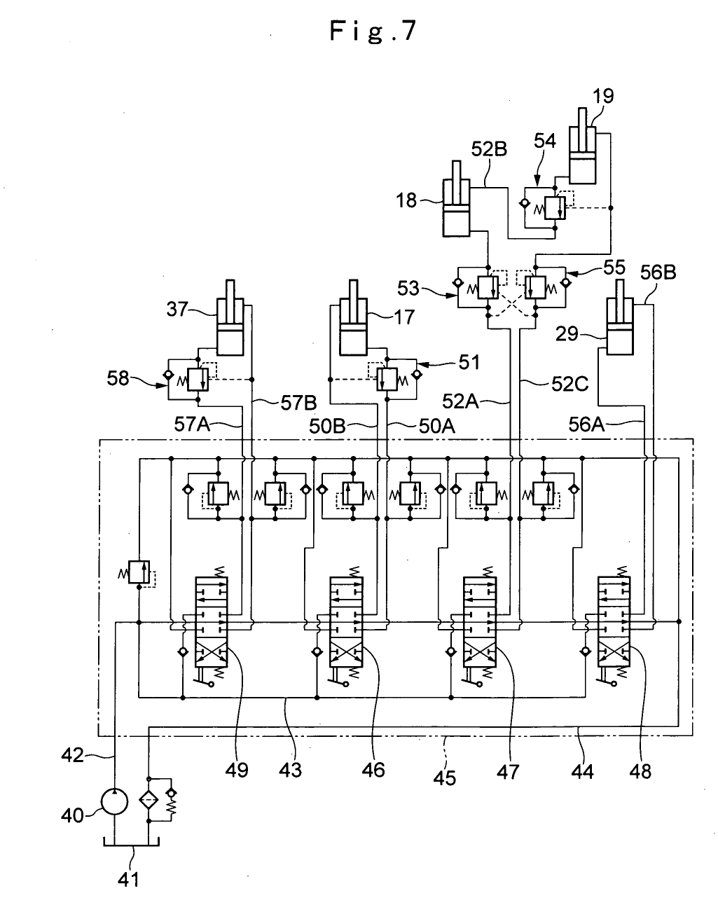

Now, referring to FIG. 7, there is shown a diagram of hydraulic circuits for driving said boom lifting cylinder 17, first step boom cylinder 18, second step boom cylinder 19, swing cylinder 29 and tool cylinder 37.

In that figure, indicated 40 is a hydraulic pump which serves as an oil pressure source along with a tank 41. Delivery side of the hydraulic pump 40 is connected to a center bypass conduit 42. By the hydraulic pump 40 which is driven by an engine, operating oil in the tank 41 is delivered to the boom lifting cylinder 17, first step boom cylinder 18, second step boom cylinder 19, swing cylinder 29 and tool lo cylinder 37 through the center bypass conduit 42 as high pressure oil. Further connected to the center bypass conduit 42 is a pump conduit 43 which is connected to input ports of directional control valves 46, 47, 48 and 49 which will be described hereinafter.

Denoted at 44 is a return conduit which connects the respective directional control valves 46, 47, 48 and 49 with the tank 41. As pressure oil from the hydraulic pump 40 is supplied to the boom lifting cylinder 17, for example, return oil from the boom lifting cylinder 17 fed back to the tank 41 through the return conduit 44.

Indicated at 45 is a group of control valves which are connected to the center bypass conduit 42, pump conduit 43 and return conduit 44. In this instance, the control valves 45 is constituted by the boom lifting directional control valve 46 which controls the direction of pressure oil to be fed to and from the boom lifting cylinder 17, the boom expanding or contracting directional control valve 47 which controls the direction of pressure oil to be fed to and from the first step boom cylinder 18 and the second step boom cylinder 19, the tool repositioning mechanism directional control valve 48 which controls the direction of pressure oil to be fed to and from the swing cylinder 29, and the tool operating directional control valve 49 which controls the direction of pressure oil to be fed to and from the tool cylinder 37. These directional control valves 46, 47, 48 and 49 are connected parallel with each other.

In this instance, the directional control valve 46 is connected to a bottom-side oil chamber of the boom lifting cylinder 17 through a conduit 50A, and at the same time connected to a rod-side oil chamber of the boom lifting cylinder 17 through a conduit 50B. A counterbalance valve 51 is provided in the course of the conduit 50A to prevent an abrupt fall of the telescopic boom 12 as the latter is lowered by the boom lifting cylinder 17 toward the ground surface from an upper elevated position.

The directional control valve 47 is connected to a bottom-side oil chamber of the first step boom cylinder 18 through conduit 52A, and a rod-side oil chamber of the first step boom cylinder 18 is connected to a bottom-side oil chamber of the second step boom cylinder 19 through conduit 52B. Rod-side oil chamber of the second step boom cylinder 19 is connected to the directional control valve 47 through conduit 52C.

Therefore, when pressure oil from the hydraulic pump 40 is supplied to the bottom-side oil chamber of the first step boom cylinder 18 from the directional control valve 47 through the conduit 52A, pressure oil which is discharged from the rod-side oil chamber of the first step boom cylinder 18 is supplied to the bottom-side oil chamber of the second step boom cylinder 19 through the conduit 52B, and pressure oil which is discharged from the rod-side oil chamber of the second step boom cylinder 19 is returned to the tank 41 through the conduit 52C, directional control valve 47 and return conduit 44. Inversely, when pressure oil from the hydraulic pump 40 is supplied from the directional control valve 47 to the rod-side oil chamber of the second step boom cylinder 19 through the conduit 52C, pressure oil which is discharged from the bottom-side oil chamber of the second step boom cylinder 19 is supplied to the rod-side oil chamber of the first step boom cylinder 18 through the conduit 52B, and pressure oil which is discharged from the bottom-side oil chamber of the first step boom cylinder 18 is returned to the tank 41 through the conduit 52A, directional control valve 47 and return conduit 44.

In this manner, the first step boom cylinder 18 and second step boom cylinder 19 are constantly operated in synchronism with each other. As a result, the second step boom 14 is expanded and contracted relative to the first step boom 13 in synchronism with expansion and contraction of the third step boom 15 relative to the second step boom 14.

A counterbalance valve 53 is provided in the course of the conduit 52A to prevent an abrupt contracting movement of the second step boom 14, and a counterbalance valve 54 is provided in the course of the conduit 52B to prevent an abrupt contracting movement of the third step boom 15. Further, a counterbalance valve 55 is provided in the course of the conduit.52C to prevent an abrupt expanding movement of second step boom 14 and third step boom 15.

The directional control valve 48 is connected to a bottom-side oil chamber of the swing cylinder 29 through conduit 56A, and at the same time connected to a rod-side oil chamber of the swing cylinder 29 through conduit 56B.

Furthermore, the directional control valve 49 is connected to a bottom-side oil chamber of the tool cylinder 37 through conduit 57A, and at the same time connected to a rod-side oil chamber of the tool cylinder 37 through conduit 57B. A counterbalance valve 58 is provided in the course of the conduit 57A to prevent the cargo handling tool 35 from being put in an abrupt downward rocking movement by the tool cylinder 37.

With the construction as described above, the lift truck 1 of the present embodiment is operated in the manner as follows.

Firstly, at the time of a cargo handling operation by the use of the lifting boom mechanism 11, a cargo of goods (not shown) is loaded on the fork 35A of the cargo handling tool 35, with the telescopic boom 12 flatly folded on the side of the ground as shown in FIG. 1. Then, after driving the lift truck 1 to a working sport, the footing plates 7A of the stabilizers 7 are set on the ground to stabilize the vehicle body 2.

In the next place, the boom lifting directional control valve 46, the boom expanding/contracting directional control valve 47 and the tool operating directional control valve 49 are operated by an operator within the cab 6 to supply pressure oil from the hydraulic pump 40 to the boom lifting cylinder 17, first step boom cylinder 18, second step boom cylinder 19 and the tool cylinder 37.

By so doing, the boom lifting cylinder 17 is expanded to let the telescopic boom 12 stand up to the elevated position indicated by two-dot chain line in FIG. 1 from the folded position indicated by solid line in the same figure. Then, the second step boom 14 is extended out of the first step boom 13 by the first step boom cylinder 18, and the third step boom 15 is extended out of the second step boom 14 by the second step boom cylinder 19.

On the other hand, by the tool cylinder 37, the cargo handling tool 35 is swung relative to the tool mount member 30 according to the elevation angle of the telescopic boom 12 to maintain the fork 35A of the cargo handling tool 35 constantly in a horizontal posture. In this manner, a cargo of goods which are loaded on the fork 35A of the cargo handling tool 35 can be lifted up from the ground in a stabilized state and transferred to a specified cargo unloading spot.

In this instance, in case the position of the lifted cargo lifted by the boom mechanism 11 is deviated from a specified cargo unloading spot in a lateral direction, that is, in a rightward or leftward direction, it becomes necessary for the operator to adjust the cargo on the boom mechanism 11 in a rightward or leftward direction to bring same into a regularly confronting position relative to the specified cargo unloading spot. In such a case, the operator actuates the directional control valve 48 in such a way as to supply pressure oil from the hydraulic pump 40 to the swing cylinder 29 of the tool repositioning mechanism 20.

In case the swing cylinder 29 is expanded, the swing arm 25 is swung about the first link pin 26 in a rightward direction and shifted from the center position in FIG. 4 to the rightward shifted position in FIG. 5, the tool mount member 30 on the fore end of the swing arm 25 is swung in a rightward direction while maintaining parallel relations with the head member 21 by link 34. As a consequence, the cargo handling tool 35 which is supported on the tool mount member 30 is linearly shifted and repositioned in a rightward direction on the front side of the telescopic boom 12, along with a cargo which is loaded on the fork 35A.

On the other hand, in case the swing cylinder 29 is contracted, the swing arm 25 is swing about the first link pin 26 in a leftward direction and its position is shifted from the center position in FIG. 4 to the leftward shifted position in FIG. 6, and the cargo handling tool 35 which is loaded with a cargo on the fork 35A is linearly shifted and repositioned in a leftward direction on the front side of the telescopic boom 12.

In this manner, according to the present embodiment, when a lifted cargo on the boom mechanism 11 is found to be deviated in a lateral direction relative to a specified cargo unloading spot, the cargo handling tool 35 can be linearly repositioned in a rightward or leftward direction by the tool repositioning mechanism 20 to offset the positional deviation. Thus, the position of the cargo handling tool 35 can be easily adjusted relative to a specified cargo unloading spot, and the cargo on the cargo handling tool 35 can be unloaded accurately on a specified spot.

Besides, according to the present embodiment, the position of the cargo handling tool 35 can be shifted linearly at the fore end of the telescopic boom 12. That is to say, in contrast to the afore-mentioned prior art in which is arranged to swing a working tool arcuately in a rightward or leftward direction, the cargo handling tool 35 is shifted linearly to maintain the same angle with respect to an unloading spot, letting the cargo of goods on the cargo handling tool 35 confront an unloading spot always from a straightforward direction. Accordingly, a cargo of goods on the cargo handling tool 35 can be smoothly unloaded on a specified unloading spot.

Furthermore, as described above, the tool repositioning mechanism 20 is arranged to shift the position of the cargo handling tool 35 linearly to the right or to the left of the fore end of the telescopic boom 12 (the fore end of the third step boom 15). Therefore, irrespective of the length of the telescopic boom 12, the position of the cargo handling tool 35 can be shifted to the right or to the left of the boom over a constant distance.

Further, according to the present embodiment, the first link pin 26, which pivotally connects the swing arm 25 to the head member 21, is disposed such that its center axis 01-01 becomes substantially parallel with the ground surface when the telescopic boom 12 is folded on the side of the ground surface (FIG. 3).

Accordingly, when the telescopic boom 12 is in the folded position on the side of the ground surface, the fore end of the swing arm 25 can be raised away from the ground surface by swinging up the swing arm 25 in a rightward or leftward direction through expansion or contraction of the swing cylinder 29. Therefore, as shown in FIGS. 5 and 6, the lower side of the cargo handling tool 35 (the fork 35A) which is attached to the fore end of the swing arm 25 through the tool mount member 30 can be raised by a height H.

As a consequence, for example, when the lift truck 1 is in travel on a public road with the telescopic boom 12 in the flatly folded position, the cargo handling tool 35 can be raised away from the ground surface simply by expanding or contracting the swing cylinder 29 to ensure safer travel. This means that, in raising away the cargo handling tool 35 from the ground surface, there is no need for lifting the telescopic boom 12 which might otherwise obstruct the view field of the operator who is at the control of the lift truck 1 within the cab 6. Therefore, it keeps the broad view field of the operator as driving.

Further, according to the present embodiment, the cargo handling tool 35, which is located at the lowest level relative to the ground surface when the swing arm 25 is laterally in a center position, can be raised to a higher level to the ground surface when the swing arm 25 is swung in a rightward or leftward direction by the swing cylinder 29. Therefore, at the time of a freight shipping operation by the use of the cargo handling tool 35, for example, the swing arm 25 is retained in the center position to hold the cargo handling tool 35 at the lowest level so that freight goods can be easily loaded on the fork 35A. On the other hand, when the vehicle body 2 of the lift truck 1 is put in travel to transfer freight goods which are loaded on the fork 35A, the cargo handling tool 35 can be raised to a higher level simply by swinging the swing arm 25 in a rightward or leftward direction without lifting the telescopic boom 12 to evade obstacles easily which might exist on ground surface.

Besides, according to the present embodiment, the tool repositioning mechanism 20 is pivotally supported on the tool mount member 30 by the support pin 36 to swing the cargo handling tool 35 upward and downward, and the tool cylinder 37 is provided between the tool mount member 30 and the cargo handling tool 35.

Therefore, as the telescopic boom 12 is elevated up and down, the tool cylinder 37 is expanded or contracted according to elevation angle of the telescopic boom 12 to swing the cargo handling tool 35 upward or downward. As a consequence, the fork 35A of the cargo handling tool 35 can be held always in a horizontal posture irrespective of the elevation angle of the telescopic boom 12, permitting to transfer freight goods on the fork 35A to a specified cargo unloading spot in a stabilized state.

Furthermore, according to the present embodiment, when the telescopic boom 12 is folded to the ground surface, the fore end of the third step boom 15 is located at a lower level than the base end of the first step boom 13 which is supported on the frame 3 by the support pin 16, and extended obliquely downward to the ground surface (see FIG. 1).

Therefore, as shown in FIGS. 5 and 6, even when the cargo handling tool 35 is relocated to the right or left of the telescopic boom 12 and raised away from a ground surface, it can be brought down to approach or land on a ground surface simply by extending the telescopic boom 12.

Accordingly, when the cargo handling tool 35 is used for scooping up fodder in cowshed cleaning, for example, the tool may be moved to the right and left close to a wall of the cowshed. On such an occasion, by extending the telescopic boom 12, the cargo handling tool 35 can be lowered to contact ground surface for scooping up fodder effectively in a secure manner even from border areas bounded by a wall.

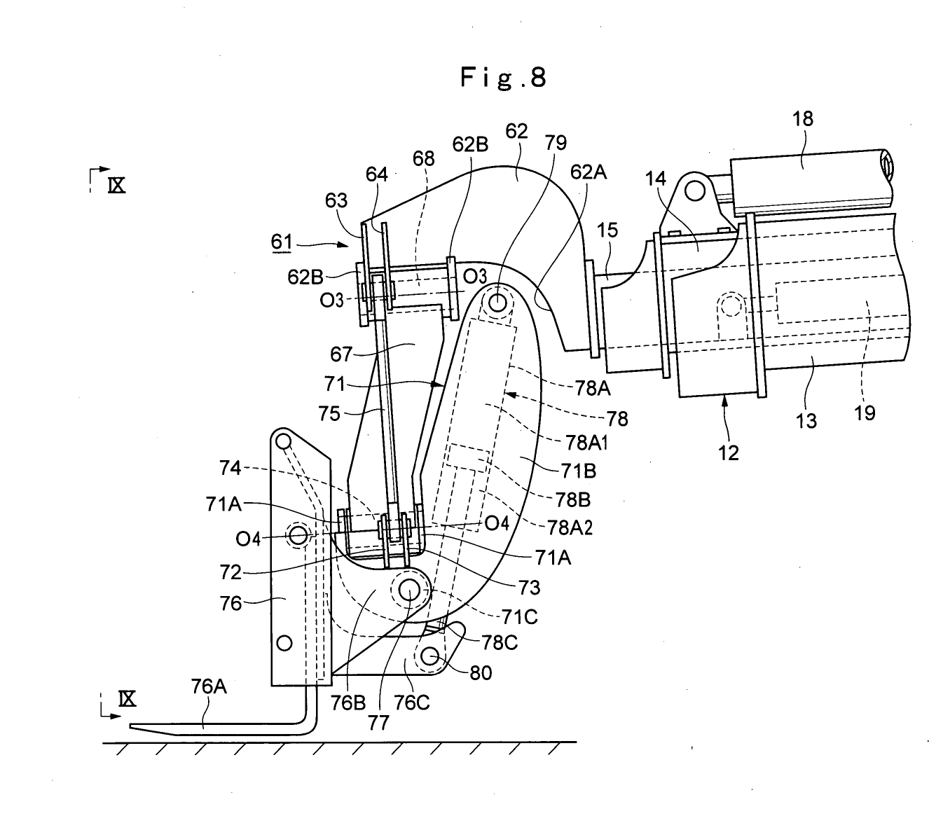

Now, turning to FIGS. 8 to 11, there is shown a second embodiment of the present invention. This embodiment has features in that the swing cylinder and the link of the tool repositioning mechanism are located in positions on the opposite sides of the swing arm. In the following description of the second embodiment, those component parts which are identical with the counterparts in the foregoing first embodiment are simply designated by the same reference numerals or characters to avoid repetitions of same descriptions.

In the drawings, indicated at 61 is a tool repositioning mechanism which is adopted in the second embodiment in place of the tool repositioning mechanism 20 in the foregoing first embodiment. This tool repositioning mechanism 61 is provided between the third step boom 15 of the telescopic boom 12 and a cargo handling tool 76, which will be described hereinafter, for moving the cargo handling tool 76 to the right or to the left of the telescopic boom 12. Similarly to the tool repositioning mechanism 20 in the first embodiment, the tool repositioning mechanism 61 of the present embodiment is constituted by a head member 62, swing arm 67, swing cylinder 70, tool mount member 71 and link 75, which will be described hereinafter. However, the present embodiment differs from the foregoing first embodiment in that the swing cylinder 70 and the link 75 are located in positions on the opposite sides of the swing arm 67.

Designated at 62 is a head member which is securely fixed to the fore end of the third step boom 15, and in the form of a substantially L-shaped hollow tube extending forward from the third step boom 15. In this instance, at the base end of the head member 62 which is securely fixed to the third step boom 15, the head member 62 is provided with a concave indented portion 62A to evade a tool mount member 71 which will be described hereinafter. Further, a couple of arm attaching plates 62B are provided face to face in front and rear spaced positions at the front end of the head member 62. A base portion of a swing arm 67 is pivotally supported between the two arm attaching plates 62B in the manner as described hereinafter.

Projected from the left side of the head member 62 are a couple of brackets 63 and 64 at spaced positions in the longitudinal direction of the head member 62 to support therebetween a base end portion of a link 75 which will be described hereinafter. On the other hand, projected from the right side of the head member 62 are a couple of brackets 65 and 66 at spaced positions in the longitudinal direction of the head member 62 to connect thereto a bottom side of a swing cylinder 70 which will be described hereinafter.

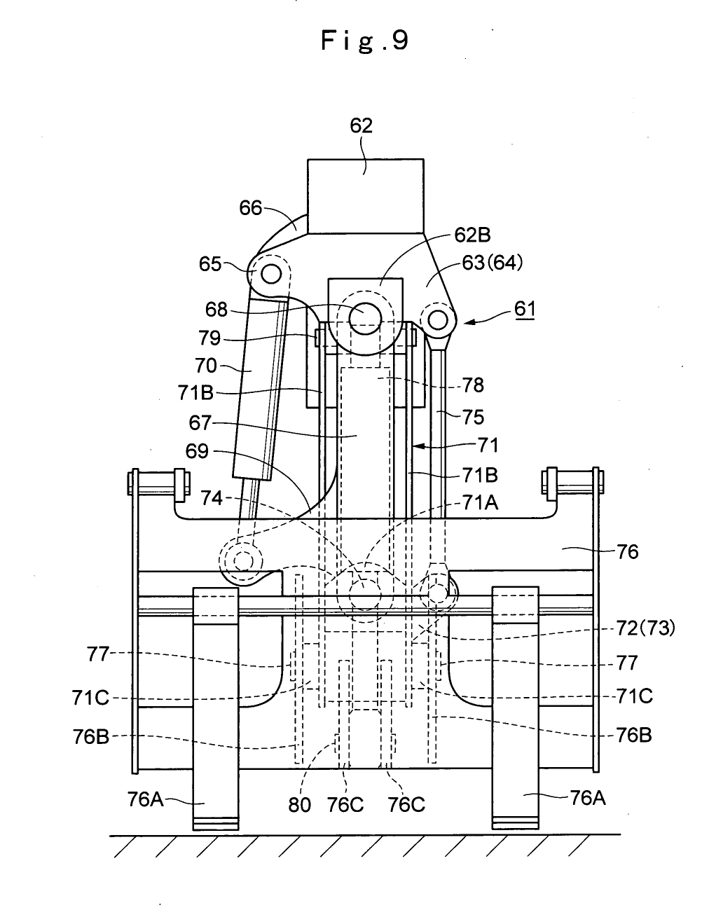

Indicated at 67 is a swing arm which is pivotally supported on a fore end portion of the head member 62 for rightward and leftward swinging or rocking movements. This swing arm 67 is in the form of a hollow tube which is extended obliquely downward from base end (higher portion) to fore end (lower portion) as shown in FIG. 8. Base end of the swing arm 67 is pivotally supported by a first link pin 68 between the arm attaching plates 62B of the head member 62. Attached to a fore end portion (a lower end portion) of the swing arm 67 is a tool mount member 71 which will be described hereinafter. Further, as shown in FIG. 9, a pair of brackets 69 (only one bracket is shown in the drawings) are projected from the right side of the swing arm 67 at spaced front and rear positions to connect thereto the rod side of a swing cylinder 70 which will be described hereinafter.

In this instance, when the telescopic boom 12 is folded to the ground surface as shown in FIG. 8, center axis 03-03 of the first link pin 68 is disposed substantially parallel with the ground surface. Therefore, when the telescopic boom 12 is in the folded position, the cargo handling tool 76 can be raised away from a ground surface by swinging the swing arm 67 in a rightward or leftward direction.

Indicated at 70 is a swing cylinder which is provided between the head member 62 and the swing arm 67. As shown in FIG. 9, the swing cylinder 70 is located on the right side of the swing arm 67. In this instance, bottom side of the swing cylinder 70 is pivotally connected to the brackets 65 and 66 at the right side of the head member 62 through a pin, while rod side of the swing cylinder 70 is pivotally connected to the brackets 69 at the right side of the swing arm 67 through a pin. By the swing cylinder 70, the swing arm 67 is swung laterally in rightward and leftward directions about the first link pin 68.

Denoted at 71 is a tool mount member which is attached to a fore end portion of the swing arm 67. As shown in FIG. 8, the tool mount member 71 is located on the back side of the swing arm 67 (on the side of the telescopic boom 12), and extended in the longitudinal direction of the swing arm 67. In this case, the tool mount member 71 is constituted by a pair of front and rear sides arm attaching plates 71A which are located in spaced positions on the front and rear sides of a fore (lower) end portion of the swing arm 67, a pair of right and left cylinder attaching plates 71B which are located face to face on the right and left sides of the arm attaching plates 71A and extended along the back side of the swing arm 67, and right and left boss portions 71C which are projected from the cylinder attaching plates 71B at a position lower than the arm attaching plates 71A. Further, a pair of brackets 72 and 73 are projected from the left side of the tool mount member 71 (a cylinder attaching plate 71B) at spaced front and rear positions to connect thereto a fore end portion of a link 75 which will be described hereinafter.

The above-mentioned arm attaching plates 71A of the tool mount member 71 are pivotally supported on a fore end portion of the swing arm 67 by a second link pin 74 for rocking movements in rightward and leftward directions. Further, connected to fore (upper) end portions of the cylinder attaching plates 71B is a tube 78A of a tool cylinder 78 which will be described hereinafter. A cargo handling tool 76, which will also be described hereinafter, is supported on the right and left boss portions 71C.

In this instance, the second link pin 74 is located such that its center axis 04-04 is disposed substantially parallel with a ground surface when the telescopic boom 12 is folded to the ground surface as shown in FIG. 8. That is to say the center axis 04-04 of the second link pin 74 and the center axis 03-03 of the first link pin 68 are in parallel relations with each other.

Indicated at 75 is a rod-like link which is provided between the head member 62 and the tool mount member 71. As shown in FIG. 9, the link 75 is located on the left side of the swing arm 67. That is to say, according to the present embodiment, the swing cylinder 70 and the link 75 are located on the opposite sides of the swing arm 67.

In this instance, a base end portion of the link 75 is pivotally connected to the brackets 63 and 64 on the head member 62 by a pin, while a fore end portion of the link 75 is pivotally connected to the brackets 72 and 73 on the tool mount member 71 by a pin. The link 75 forms a parallel link mechanism in cooperation with the head member 62, swing arm 67 and tool mount member 71 thereby to maintain the posture of the tool mount member 71 substantially in parallel relations with the head member 62 when the swing arm 67 is swing in a rightward or leftward direction by the swing cylinder 70, as shown in FIGS. 9 to 11.

Indicated at 76 is a cargo handling tool which is pivotally supported on the tool mount member 71 for upward and downward rocking movements. The cargo handling tool 76 is substantially in the form of a rectangular frame structure which is provided with a fork 76A on the front side for loading a cargo of freight goods thereon. In this instance, tool stay attaching plates 76B and cylinder attaching plates 76C are projected rearward on the back side of the cargo handling tool 76. The tool stay attaching plates 76B are located in corresponding positions relative to the boss portions 71C of the tool mount member 71, while the cylinder attaching plates 76C are located in lower positions than the tool stay attaching plates 76B, namely, located at the lower end of the cargo handling tool 76. The tool stay attaching plates 76B are pivotally supported on the boss portions 71C of the tool mount member 71 by a support pin 77 for upward and downward rocking movements.

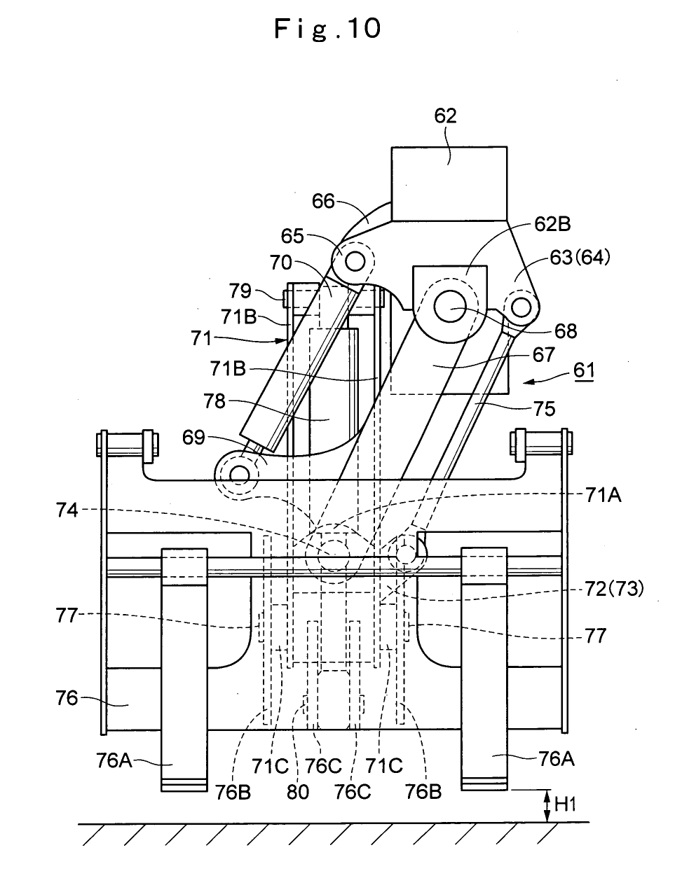

Accordingly, as the swing cylinder 70 is contracted, the swing arm 67 is swung in a rightward direction about the first link pin 68 to shift its position from the center position in FIG. 9 to a rightward shifted position in FIG. 10. At this time, the tool mount member 71 which is supported at the fore end of the swing arm 67 is swung in the rightward direction along with the swing arm 67, being kept substantially in a parallel posture relative to the head member 62 by the link 75. As a result, the cargo handling tool 76 which is supported by the tool mount member 71 is shifted to the right of the telescopic boom 12, and at the same time raised away from a ground surface by a height H1.

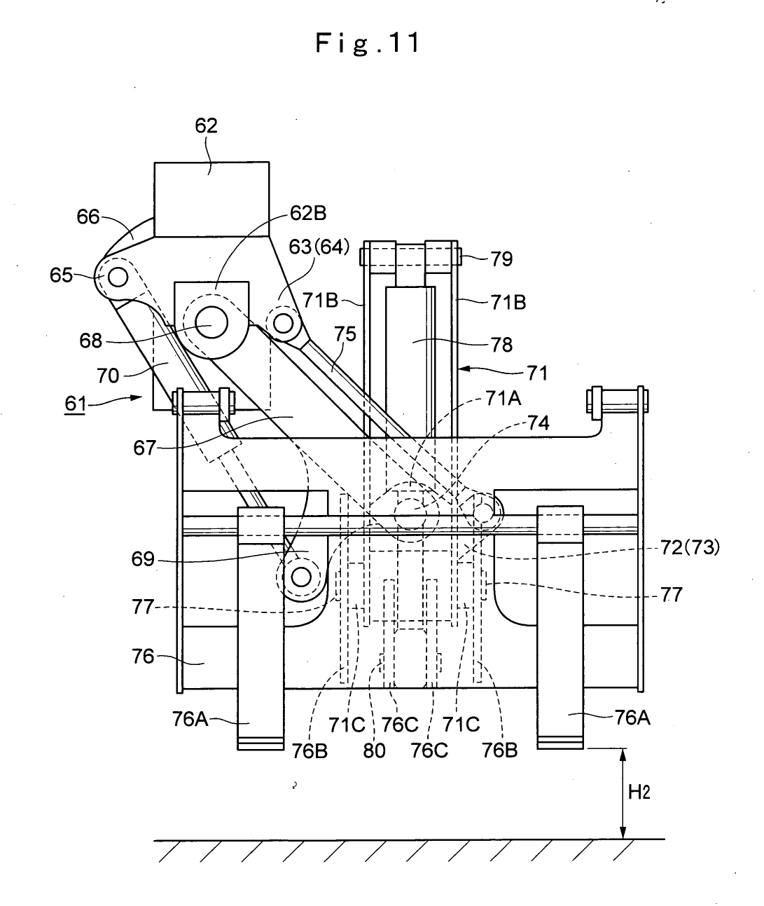

On the other hand, when the swing cylinder 70 is expanded, the swing arm 67 is swung in a leftward direction about the first link pin 68 and shifted from the center position in FIG. 9 to a leftward shifted position in FIG. 11. At this time, the tool mount member 71 which is supported at the fore end of the swing arm 67 is swung in the leftward direction along with the swing arm 67, being kept substantially in a parallel posture relative to the head member 62 by the link 75. As a consequence, the cargo handling tool 76 which is supported by the tool mount member 71 is shifted to the left of the telescopic boom 12, and at the same time raised away from a ground surface by a height H2.

Of course, the height H1 of the cargo handling tool 76 at the rightward shifted position of the swing arm 67 and the height H2 of the cargo handling tool 76 at the leftward shifted position of the swing arm 67 can be adjusted suitably by changing the stroke length of the swing cylinder 70.

Indicated at 78 is a tool cylinder which is provided on the back side of the swing arm 67 and connected between the tool mount member 71 and the cargo handling tool 76. This tool cylinder 78 is located closer to the telescopic boom 12 than a connecting point (the position of the support pin 77) at which the cargo handling tool 76 is connected to the tool mount member 71, and between the cylinder attaching plates 71B of the tool mount member 71.

In this instance, the tool cylinder 78 is constituted by a tube 78A, a piston 78B which is slidably fitted in the tube 78A, and a rod 78C which is connected to the piston 78B at its base end and projected out of the tube 78A at its fore end. A bottom-side oil chamber 78A1 and a rod-side oil chamber 78A2 are defined within the tube 78A. Further, the tube 78A of the tool cylinder 78 is pivotally connected to fore end (upper end) portions of the cylinder attaching plates 71B of the tool mount member 71 by a pin 79, while the rod 78C of the tool cylinder 78 is pivotally connected to the cylinder attaching plates 76C on the side of the cargo handling tool 76 by a pin 80.

By the tool cylinder 78, the cargo handling tool 76 is swung about the support pin 77 in upward and downward directions relative to the tool mount member 71 to maintain the fork 76A of the cargo handling tool 76, loaded with freight goods, constantly in a horizontal posture irrespective of the elevation angle of the telescopic boom 12. The tool cylinder 78 is arranged to use the oil pressure within the bottom-side oil chamber 78A1 of the tool cylinder 78 in supporting loads which are exerted thereto from the side of the cargo handling tool 76.

Being arranged in the manner as described above, the tool repositioning mechanism 61 according to the present embodiment can shift the position of the cargo handling tool 76 linearly in rightward or leftward direction to offset a deviation of the cargo handling tool 76 in a lateral direction. Accordingly, the freight goods on the cargo handling tool 76 can be accurately unloaded on a specified cargo unloading spot.

Besides, the tool repositioning mechanism 61 according to the present embodiment has the swing cylinder 70 and the link 75 located on the right and left sides of the swing arm 67, so that a thickness dimension of the tool repositioning mechanism 61 can be minimized. It follows that the total length of the boom mechanism can be minimized to ensure higher stability of the lift truck in cargo handling operations. In addition, it becomes possible to contract the telescopic boom 12 into a minimal size for increasing stability of the lift truck in travel.

Moreover, according to the present embodiment, the tool cylinder 78 is located on the back side of the swing arm 67 and between the tool mount member 71 and the cargo handling tool 76, utilizing the pressure in the bottom-side oil chamber 78A1 of the tool cylinder 78 for supporting loads which are -exerted on the tool cylinder 78 by the cargo handling tool 76. Therefore, even if a cargo of an increased weight is loaded on the cargo handling tool 76, an increased load which is exerted from the cargo handling tool 76 can be securely supported by the tool cylinder 78. Therefore, it becomes possible to lift cargoes of greater weights by the cargo handling tool 76. Otherwise, it becomes possible to downsize the tool cylinder 78.

Further, according to the present embodiment, the tool mount member 71 is provided with a pair of right and left cylinder attaching plates 71B which are faced with each other and extended along the longitudinal direction of the swing arm 67, and the tool cylinder 78 is located between the right and left cylinder attaching plates 71B. Accordingly, the tool cylinder 78 can be suitably covered and protected by the two cylinder attaching plates 71B of the tool mount member 71.

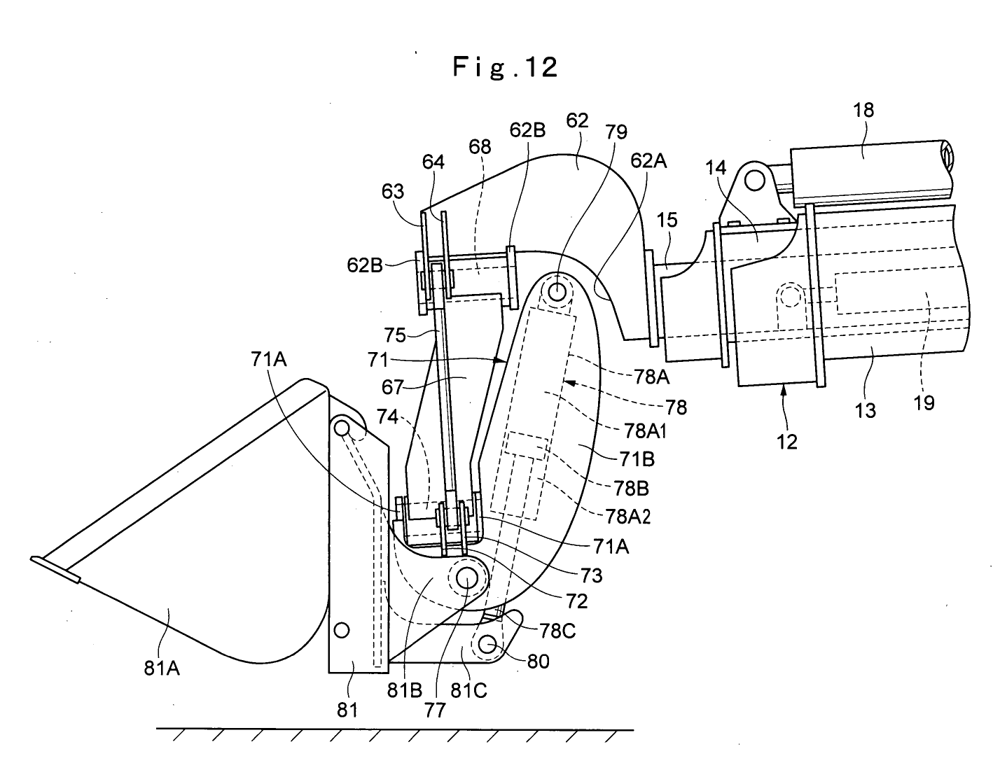

In the foregoing first and second embodiments of the invention, the cargo handling tool 35 (76) with fork 35A (76A) is shown as a working tool. Needless to say, the present invention is not restricted to working tools of this sort. For example, as shown in a modification of FIG. 12, there may be employed a excavating tool 81 which is provided with a bucket 81A on the front side and with tool stay attaching plates 81B and cylinder attaching plates 81C on the back side.

Further, in the foregoing embodiments, the present invention is applied by way of example to a lift truck 1 which is provided with stabilizers 7 in a front portion of the vehicle body 2. However, it is to be understood that the present invention is similarly applicable to lift trucks which are not provided with stabilizers.

Furthermore, in the foregoing embodiments, the present invention is applied to a three-step telescopic boom which is composed of a first step boom 13, second step boom 14 and third step boom 15. However, the present invention can be similarly applied to a two-step telescopic boom or a telescopic boom of more than four steps.

Moreover, in the foregoing embodiments, the present invention is applied by way of example to a lift truck 1 which is provided with a cargo handling tool 35 at the fore end of the telescopic boom 12. However, it is to be understood that the present invention can be similarly applied to other automotive working machines, for example, to an automotive working machine for higher place which is provided with a working deck for operator at the fore end of a lifting boom.

1. (canceled)

2. An automotive working machine having an automotive vehicle body, and a boom mechanism liftably supported on said vehicle body, said boom mechanism being provided with a multiple step telescopic boom supported on said vehicle body at its base end liftable up and down and contractibly extensible, and a working tool attached to a foremost boom section of said telescopic boom, characterized in that said automotive working machine comprises:
a tool repositioning mechanism provided between said foremost boom and said working tool and adapted to shift said working tool laterally in a rightward or leftward direction relative to said telescopic boom,
said tool repositioning mechanism comprises, a head member provided on a fore end portion of said foremost boom, a swing arm having a base or upper end swingably supported on said head member through a first link pin for rightward and leftward swinging movements relative to said head member, a swing cylinder connected between said head member and said swing arm to swing said swing arm in a rightward or leftward direction relative to said head member, a tool mount member swingably supported on a fore end portion of said swing arm through a second link pin for rightward and leftward swinging movements about said second link pin along with said working tool, and a link connected between said head member and said tool mount member to maintain said tool mount member substantially in parallel relation with said head member.

3. An automotive working machine as defined in claim 2, wherein said first link pin is so located as to take substantially a parallel position relative to a ground surface when said telescopic boom is folded to ground surface.

4. An automotive working machine as defined in claim 2, wherein said working tool is pivotally supported on said tool mount member through a support pin for upward and downward swing movements about said support pin, further comprising a tool cylinder connected between said working tool and said tool mount member to swing said working tool.

5. An automotive working machine as defined in claim 2, wherein said swing cylinder and said link are located collectively at one side of said swing arm.

6. An automotive working machine as defined in claim 2, wherein said swing cylinder and said link are located on opposite sides of said swing arm.

7. An automotive working machine as defined in claim 4, wherein said tool cylinder is connected between said tool mount member and said working tool on the front side of said swing arm.

8. An automotive working machine as defined in claim 4, wherein said tool cylinder is connected between said tool mount member and said working tool on the back side of said swing arm in such a way as to utilize pressure in a bottom-side oil chamber for supporting loads exerted thereto by said working tool.

9. An automotive working machine as defined in claim 4, wherein said tool mount member is provided with a couple of right and left cylinder attaching plates faced toward each other on the back side of said swing arm and extended in the longitudinal direction of said swing arm in spaced relations with each other, said swing cylinder being located in position between said right and left cylinder attaching plates and connected between said tool mount member and said working tool.

10. (canceled)
